(19) United States
(12) Patent Application Publication
(10) Pub. No.: US 2003/0083906 A1
(43) Pub. Date: May 1, 2003

(54) Method and apparatus for processing health insurance applications over a network

(76) Inventors: Eric J. Howell, Folsom, CA (US); Samuel C. Gibbs III, Portola Valley, CA (US); Nitin M. Patel, Glendale, AZ (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/016,302

(22) Filed: Oct. 29, 2001

(51) Int. Cl. G06F 17/60

(52) U.S. Cl. 705/4

(57) ABSTRACT

An apparatus and method of processing health insurance applications over a network are described. In one embodiment, a user interface is presented to an applicant over a network. The user interface prompts the applicant for application data such as applicant identification, medical history, or other information required to process the health insurance application. When the application data specified by the user is received, the application data is transformed into a secure digital file, such as a portable document format (PDF) file. The secure digital file is then delivered to a health insurance carrier via the network.

### BACKGROUND OF THE INVENTION

1. Field of the Invention

The present invention relates generally to the field of e-commerce and, more specifically, to processing health insurance applications over a network.

2. Discussion of Related Art

Millions of Americans today live without health insurance. Their plight is only exacerbated by the difficulty they face trying to obtain it. There are thousands of health insurance plans to choose from, varying forms to fill out for each plan, and long waiting periods while the paperwork is shuffled from desk to desk for weeks on end.

In an attempt to make obtaining health insurance more efficient, some health insurance service providers (e.g., health insurance carriers, brokers, etc.) have turned to the Internet attempting to provide a direct sales or brokerage service that benefits from a paperless network to expedite the process. However, the current approach has only slightly improved the process. For instance, these service providers have provided an online framework that allows health insurance customers to obtain quotes for the available plans, review the benefits associated with the plans, and input their own personal, financial and health related data necessary to complete the application selected by the customer. However, once the applicant has selected a plan and the service provider has collected the applicant's data, such service provider must use the applicant's data to complete the carrier-approved application, print out the application and send the application to the applicant for a signature. Then, the applicant must return the paper contract back to the service provider, with a signature and a form of payment. Then, the application data is manually entered into a carrier's underwriting system in order to make a decision on whether to issue a policy. Finally, the service provider will make several telephone calls or use another form of communication to pass information back to the customer or to request additional information from the customer. Thus, the online process still leads to a very time consuming paper chase.

What is needed, therefore, is a method of processing a health insurance application over a network in an efficient and secure manner, without spending weeks of correspondence with the customer.

### SUMMARY OF THE INVENTION

An apparatus and method of processing health insurance applications over a network are described. In one embodiment, a user interface is presented to an applicant over a network. The user interface prompts the applicant for application data such as applicant identification, medical history, or other information required to process the health insurance application. When the application data specified by the user is received, the application data is transformed into a secure digital file, such as a portable document format (PDF) file. The secure digital file is then delivered to a health insurance carrier via the network.

Other features of the present invention will be apparent from the accompanying drawings and from the detailed description that follows.

### BRIEF DESCRIPTION OF THE DRAWINGS

The present invention is illustrated by way of example and not limited by the figures of the accompanying drawings in which like references indicate similar elements and in which:

FIG. 1 is a block diagram of one embodiment of a network-based system utilizing a health insurance transaction facility.

FIG. 2 is a block diagram of one embodiment of a transaction facility.

FIG. 3 is a flow diagram of one embodiment of a method for processing health insurance application data over a network.

FIG. 4 is a flow diagram of one embodiment of a method for presenting a user interface that facilitates input of application data over a network.

FIG. 5 is a flow diagram of one embodiment of a method for transforming application data into a secure digital file.

FIG. 6 illustrates an exemplary user interface provided to facilitate an electronic signature process.

FIG. 7 is a block diagram of one embodiment of a translator used to translate application data into a preferred digital format.

FIG. 8 is a flow diagram of one embodiment of a method for collecting and processing data updates from a health insurance carrier over a network.

FIG. 9 illustrates an exemplary user interface that may be provided to a health insurance carrier.

FIG. 10 is a flow diagram of one embodiment of a method for electronically communicating processing updates to an applicant over a network.

FIG. 11 shows a diagrammatic representation of machine in the exemplary form of a computer system.

### DETAILED DESCRIPTION OF THE INVENTION

Described herein are embodiments of a method and apparatus for processing health insurance applications over a network. In the following detailed description of the present invention, numerous specific details are set forth in order to provide a thorough understanding of the present invention. However, it will be apparent to one skilled in the art that the present invention may be practiced without these specific details.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of processing blocks leading to a desired result. The processing blocks are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### Network Architecture

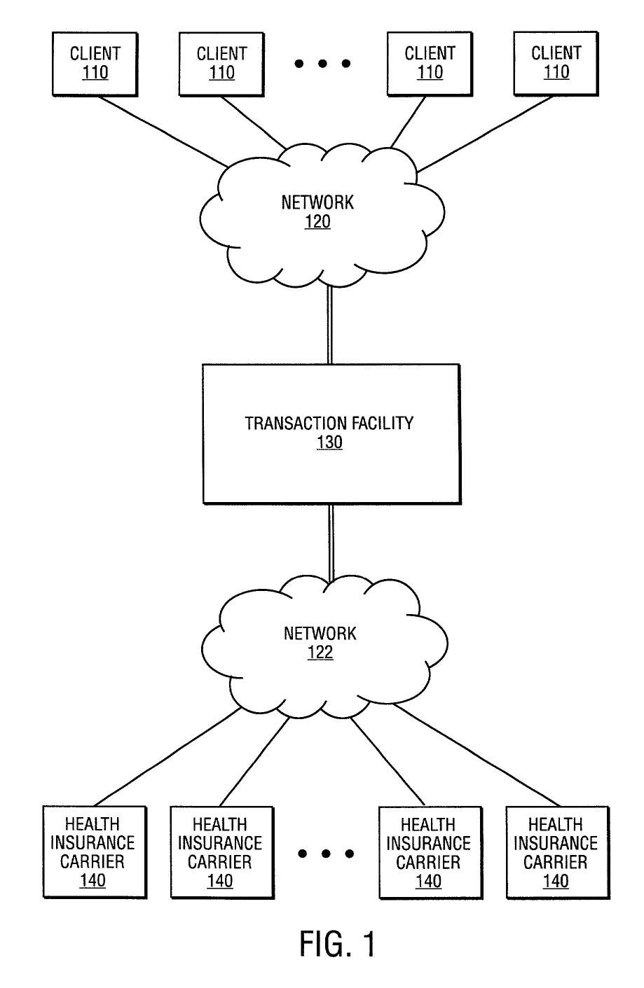

FIG. 1 is a block diagram of one embodiment of a network-based system utilizing a health insurance transaction facility. A plurality of client devices 110 are connected to a network 120. The client devices 110 can be used by customers (referred to as “clients” or “applicants”) to search for and purchase individual, family, Medicare Supplement or group health insurance products. The client devices 110 do not necessarily need to be limited to home computer systems but can be any kind of device capable of communicating over a network such as, but not limited to, personal computers, hand-held devices, cell-phones, etc.

A plurality of health insurance carrier devices 140, connected to a network 122, are used by health insurance carriers to process health insurance applications of clients 110. A transaction facility 130 assists the clients 110 and the carriers 140 in transacting the process of buying and selling health insurance over the networks 120 and 122.

Networks 120 and 122 may be the same public network (e.g., the Internet), may be the same or separate private networks (e.g., intranets, extranets, local area networks (LAN), or wireless networks), or one may be a public network while the other is a private network. In the interest of brevity, however, the general term “network” may be used hereafter to describe both networks 120 and 122 even though both networks may be separate.

In one embodiment, the transaction facility 130 represents a broker. A broker is referred to a party who acts as an intermediary between the customer and the health insurance carrier. Alternatively, the transaction facility 130 may be a part of the health insurance carrier 140.

### Operation of a Health Insurance Transaction Facility

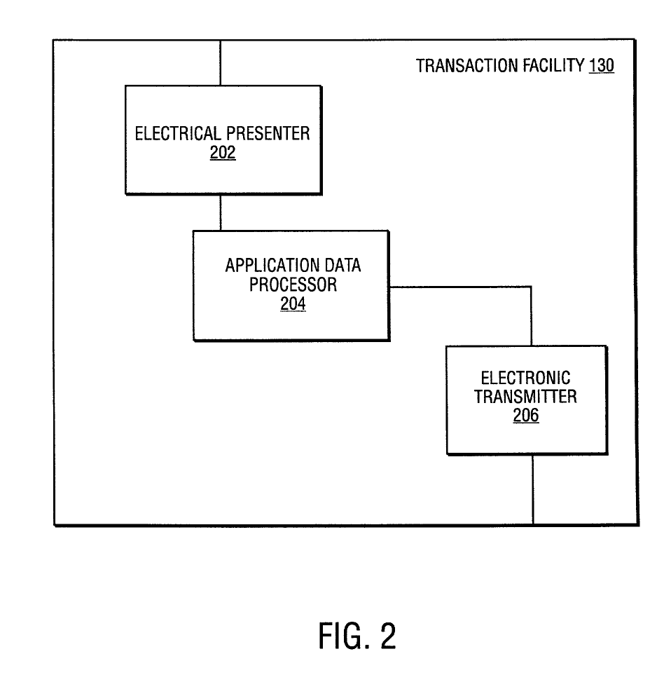

FIG. 2 is a block diagram of one embodiment of the transaction facility 130. Referring to FIG. 2, the transaction facility 130 comprises an electronic presenter 202 to present a user interface that facilitates the input of application data from an applicant, over a network. Coupled to the electronic presenter 202 is an application data processor 204 to transform the application data into a secure digital file. Coupled to the application data processor 204 is an electronic transmitter 206 to transfer the secure digital file and other application data to a health insurance carrier over the network.

The electronic presenter 202 and the electronic transmitter 206 are responsible for presenting, collecting and transmitting data over the network. In one embodiment, the electronic presenter 202 provides a user interface to enable the applicant to enter data required in an application that corresponds to a chosen health plan.

The application data processor 204 is responsible for transforming application data entered by the applicant into a secure digital file. In one embodiment, the application data processor 204 transforms the application data into a secure digital file by assembling and encrypting the application data into a preformatted electronic document (e.g., an Adobe™ portable document format (PDF) file). In one embodiment, the application data processor 204 also associates a unique electronic key with the secure digital file to enhance its security. In one embodiment, the applicant is allowed to view the secure digital file before it is submitted to the carrier. In one embodiment, after viewing the secure digital file, the applicant is provided with an opportunity to approve or reject the application.

In one embodiment, the application data processor 204 includes an electronic payment module to provide the applicant with a form of electronic payment. In one embodiment, the application data processor 204 further includes an electronic signature module to provide the applicant with a form of electronic signature to authenticate the applicant's intention to enter into a health insurance contract. In one embodiment, the application data processor 204 further includes a dynamic assembler to assemble the form of electronic payment and/or the form of electronic signature into the secure digital file.

As described above, the electronic transmitter 206 is responsible for transmitting the secure digital file including the application data to a corresponding carrier. In one embodiment, the electronic transmitter 206 provides a user interface to allow the health insurance carrier to view and print the secure digital file, to attach notes to the electronic application, and to update the status of the application.

In one embodiment, the transaction facility 130 further includes a status notifier to notify the applicant of the status of the application. In one embodiment, the transaction facility 130 allows the applicant to view attached notes and respond to the attached notes.

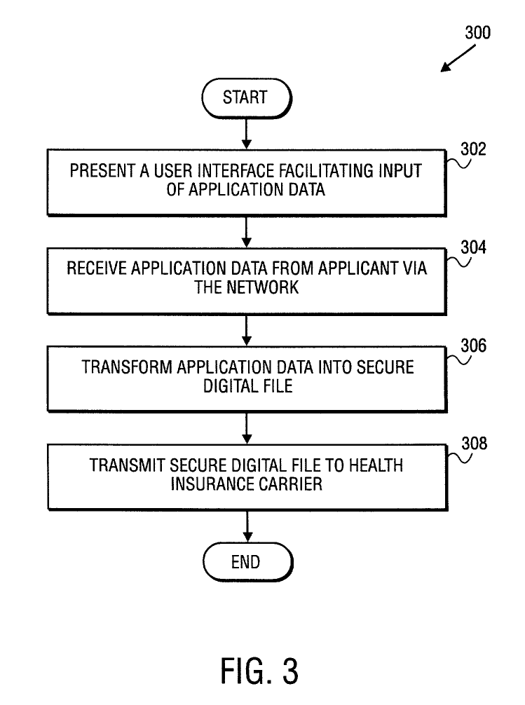

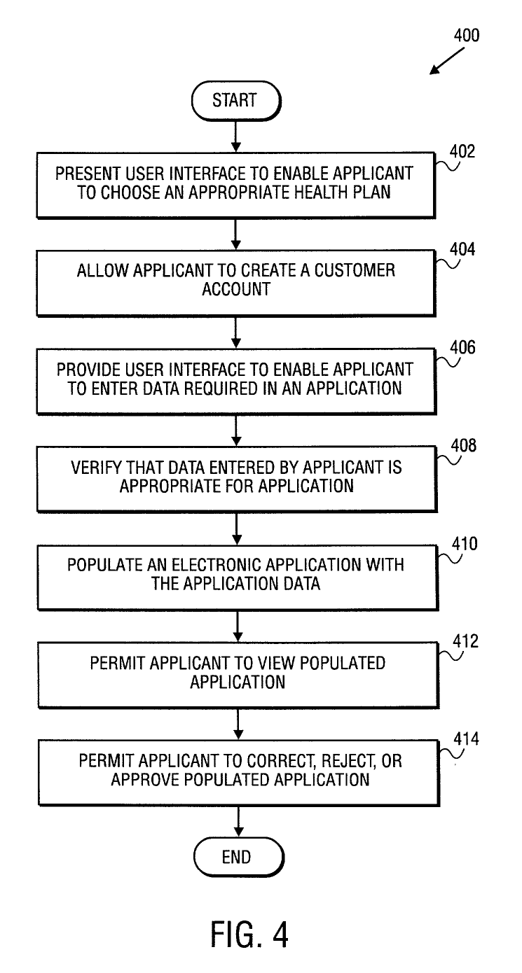

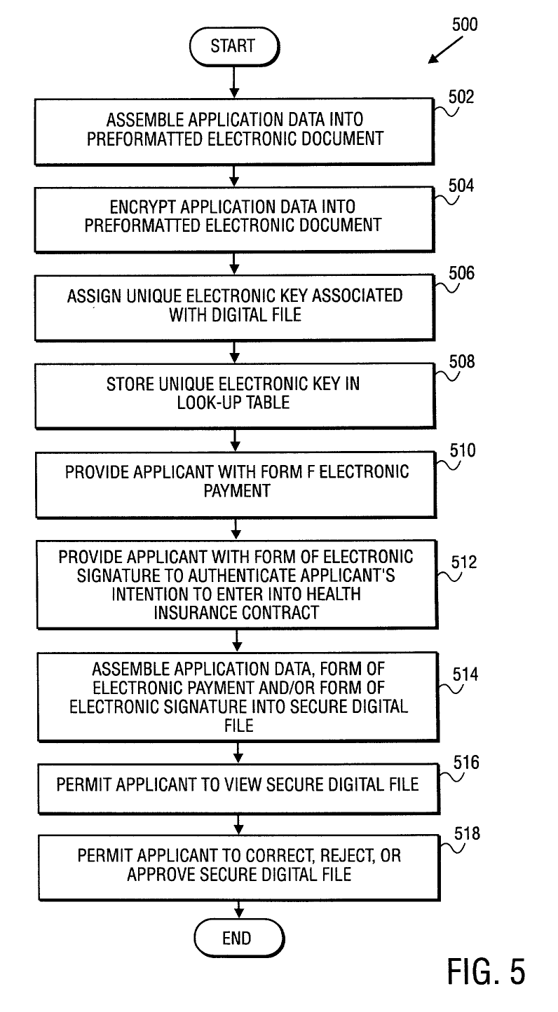

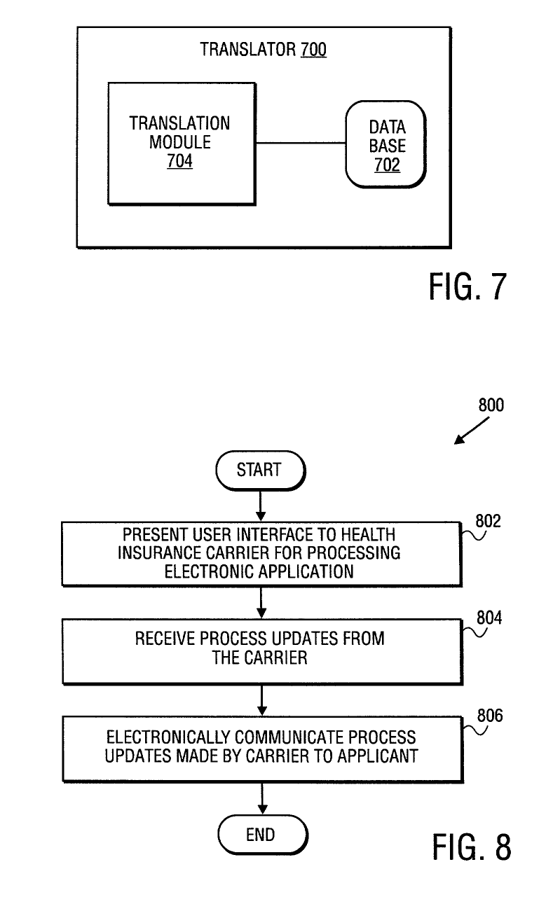

FIG. 3 is a flow diagram of one embodiment of a method 300 for processing health insurance application data over a network. Method 300 begins, at processing block 302, with presenting a user interface that facilitates the input of application data over the network. One embodiment of a method for presenting a user interface that facilitates the input of application data is described in more detail below in conjunction with FIG. 4. Next, at processing block 304, the method 300 continues with receiving the application data from the applicant via the network. Next, at processing block 306, the method 300 continues with transforming the application data into a secure digital file. One embodiment of a method for transforming the application data into a secure digital file is described in more detail below in conjunction with FIG. 5. Finally, at processing block 308, the method 300 continues with transmitting the secure digital file and other application data to the health insurance carrier. The transmission process is described in more detail below in conjunction with FIGS. 7-11.

FIG. 4 is a flow diagram of one embodiment of a method 400 for presenting a user interface that facilitates the input of application data over the network. Method 400 begins, at processing block 402, with presenting a user interface that enables, or assists, the applicant to choose an appropriate health plan. Many health insurance carriers provide a multitude of different types of health insurance plans. Therefore, a customer who does not know what health insurance plan is best for him may benefit greatly from assistance. In one embodiment, such assistance might include providing electronic informational decisions that narrow the applicant's choices. Such electronic informational decisions might consider factors such as the number of persons covered under a plan and their relation to each other and the applicant, the age of the applicant, the applicant's prior health history, the price of the plan, the plan benefits, deductible or co-pay, or the company providing the plan. In one embodiment, assistance may include notifying the applicant of his or her eligibility for a particular plan based on the applicant's medical history.

Next, at processing step 404, the method 400 continues with allowing the applicant to create a customer account. In one embodiment, for extra security, the applicant may choose a user name and password that can be used when creating the customer account. The customer account allows the applicant to save data already entered and retrieve this data at a later time. For instance, if the applicant has to disconnect from the network before he or she has finished filling out the application, the applicant can save the application in its unfinished form by creating a customer account, and then recall the saved application data at a later time when the applicant reconnects to the network. In one embodiment, the application data could be saved automatically, as the applicant provides the data, and stored on the customer account.

Next, at processing step 406, the method 400 continues with providing a user interface that enables the applicant to enter data required for an application relating to the health plan chosen. The initial user interface can be a graphical user interface (GUI), a plain text interface, etc.

Next, at processing block 408, the method 400 continues with verifying that the data entered by the applicant is appropriate for the application. In one embodiment, the user interface may be separated into electronic fields. Each field may have an associated software check that analyzes the application data as it is placed in the field and determines, according to predetermined business rules, whether the applicant has entered the appropriate information.

Next, at processing step 410, the method 400 continues with populating an electronic application with the application data. In one embodiment, the application data is placed into fields within a digitalized version of the health insurance application.

Next, at processing step 412, the method 400 continues with permitting the applicant to view the populated application. In one embodiment, the populated application may include a summary of the rates for the plan. In one embodiment, the populated application may include a summary of coverage options, such as coverage the applicant has chosen in addition to the health plan chosen.

Next, at processing step 414, the method 400 continues with permitting the applicant to correct, reject or approve of the populated application. Many advantages arise from permitting the applicant to correct, reject or approve the populated application. For example, the applicant may have entered incorrect data while providing application data, thus the applicant can then correct it. In another example, the applicant may not have paid close attention to details of the health plan, such as coverage, cost, etc., thus after viewing the populated application the applicant want to cancel the application for that particular health plan.

FIG. 5 is a flow diagram of one embodiment of a method 500 for transforming the application data into a secure digital file. An advantage of transforming the application data into a secure digital file is to protect the legal enforceability of the health insurance application. For instance, if the application data is not secured, the applicant's personal or medical history in the application may be changed (inadvertently or purposefully) after the applicant approved the application, or the applicant may claim that the application data sent to the carrier is different from the application data approved by the applicant, etc. In addition, fixed legal language within the document might also be changed, thus affecting the legal enforceability of the insurance contract. For these reasons, many health insurance carriers today are reluctant to utilize electronic applications unless they have assurances that the applicant's data and/or the legal language cannot be altered. Thus, maintaining the application data in a secure digital file protects the interests of the carrier, the customer, and all other parties involved in the application process.

The method 500 begins at processing block 502, with assembling the application data into a preformatted electronic document.

In one embodiment, the preformatted electronic document may be a digital version of the health insurance carrier's paper application with portions of text that are unalterable. Other stylistic elements of the preformatted electronic document, such as fonts, line spacing, or margins, can also be unalterable. In one embodiment, since the preformatted electronic document is an electronic version of the health insurance carrier's paper application, the format of the preformatted electronic document might mirror that of the paper document. Alternatively, the format of the preformatted electronic document may differ from that of the paper document. In one embodiment, since there are many different types of health insurance applications, the preformatted electronic document may vary widely in appearance and content. Some factors that might determine the appearance and content of the preformatted electronic document include whether the health plan chosen by an applicant is for an individual, a family, a senior citizen, or a business; which health insurance carrier is processing the application; what state or country the applicant or health insurance carrier is located in, etc. In one embodiment, the preformatted electronic document is a PDF file. Other embodiments may use other kinds of digital document formats or compressed digital document formats if they can be made secure. Yet other embodiments may utilize such file formats as sound, movie, image, program, or self-extracting archive file formats if they can be made secure.

In one embodiment, the application data is assembled into data fields of the preformatted electronic document. The data fields may look like the empty lines in a paper contract where application data would normally be inserted.

Next, at processing block 504, the method 500 continues with encrypting the application data within the preformatted digital file, thus creating a completely unalterable, secure digital file.

In one embodiment, the security of this file may be enhanced by assigning a unique electronic key that can be associated with the digital file, as shown at processing block 506. The key can be made unique by assigning a user identification number to the digital file. Further, at processing block 508, the unique electronic key is stored in a look-up table to be used when accessing the digital file. The look-up table can contain information relating the key to any or all of the applicant's personal information, which can be cross-referenced with the unique user identification number.

In one embodiment, at processing block 510, the applicant is further provided with a form of electronic payment. One form of electronic payment presented may be by credit card. Thus, in one embodiment, an interface can be presented with electronic fields wherein the applicant can provide data pertaining to a credit card of the applicant's choice. Each field may have an associated software check that analyzes the credit card data as it is placed in the field to determine, according to predetermined business rules, whether the applicant has properly completed the required information. In another embodiment, the credit card company can be contacted electronically to authenticate the validity of the credit card itself.

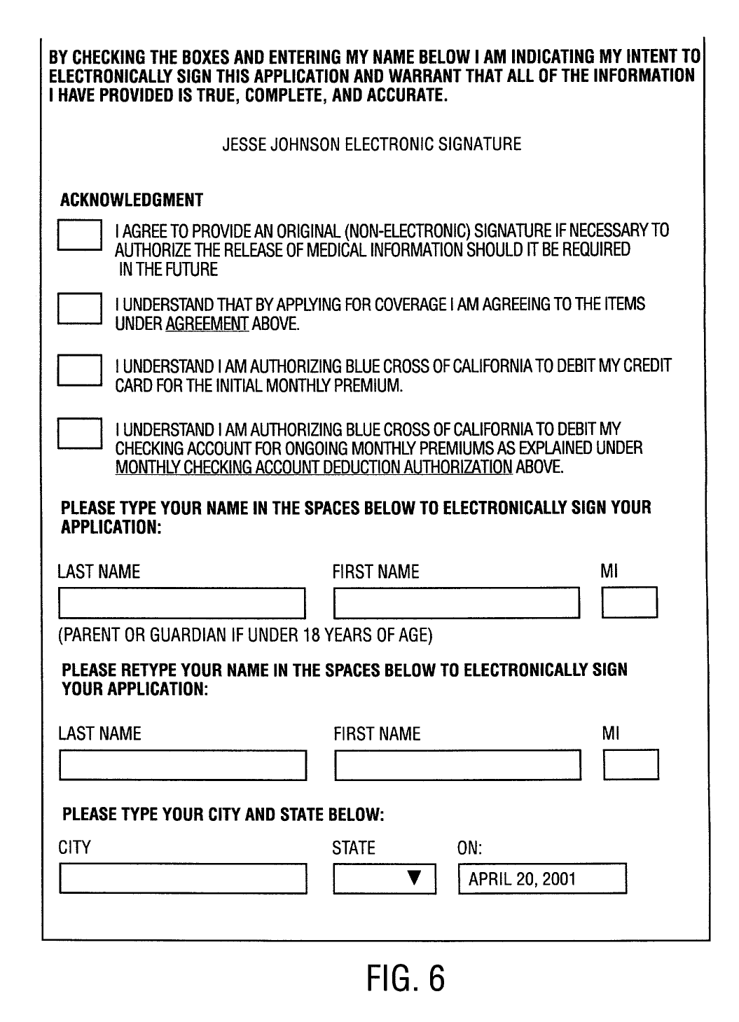

Further, at processing block 512, the applicant is provided with a form of electronic signature. The electronic signature indicates the applicant's intention to enter into a health insurance contract. In the past, electronic signatures have been an unacceptable legal form of signature and so health insurance carriers have been limited to using paper health insurance applications. Recent legislative changes, however, have made it possible for health insurance carriers to accept electronic signatures. Nevertheless, health insurance carriers may still be apprehensive about accepting them and may want to have assurance that the applicant truly intended the applicant's electronic signature to create a legally binding contract. To provide this assurance to the health insurance carrier, in one embodiment, the request for the electronic signature may employ various mechanisms for an applicant to express an intention to be legally bound by the electronic signature. Those mechanisms may include having the applicant type their name into the electronic signature twice. Another mechanism might include having the applicant type in the date. Yet another mechanism might include having the applicant check boxes or click buttons (e.g. “I Agree” button) indicating the applicant's complete intention to be legally bound to the health insurance contract. Still another mechanism might include providing the applicant with hyperlinks to portions of the application that have legally binding language, so that the applicant can view the language. FIG. 6 illustrates an exemplary user interface provided to facilitate the electronic signature process.

Returning to FIG. 5, at processing block 514, the form of electronic payment and/or the form of electronic signature are assembled into the secure digital file. In one embodiment, this may be done in the same way that application data was assembled and encrypted into a preformatted electronic document, as described in greater detail above. In one embodiment, the application data may be assembled into the secure digital file at the same time as the form of electronic payment and/or form of electronic signature are assembled into the secure digital file.

In one embodiment, the applicant is allowed to view the secure digital file, as shown at processing block 516. One advantage to the health insurance carrier of allowing the applicant to view the secure digital file is that the health insurance carrier has greater assurance that the applicant has viewed the exact language, context, and appearance that makes up the content of the digital file.

In one embodiment, the applicant is further provided with the opportunity to reject or approve the secure digital file, as shown in processing block 518.

The health insurance carrier may want to have the application data transmitted directly to the health insurance carrier's network system. To insure the security of the application data, in one embodiment the transfer of data is encrypted, or otherwise made secure. In one embodiment, the application data might be transferred via a secure hypertext transfer protocol (https). In one embodiment, the application data might be packaged into a file and transferred via a file protocol, such as the file transfer protocol (ftp). In additional embodiments, the application data might be transmitted via radio, television, cell phone, or other electronic media protocols.

In one embodiment, the health insurance carrier may want the application data delivered in a preferred digital format. FIG. 7 is a block diagram of one embodiment of a translator 700 used to translate application data into a preferred digital format. Referring to FIG. 7, in one embodiment, the translator 700 includes a database 702 and a translation module 704. The database 702 may be used to store information about what data format, or formats, a particular health insurance carrier requires. Upon receiving application data, the translator 700 may search the database 702 to verify what format the carrier requires and then convert the application data to the preferred format.

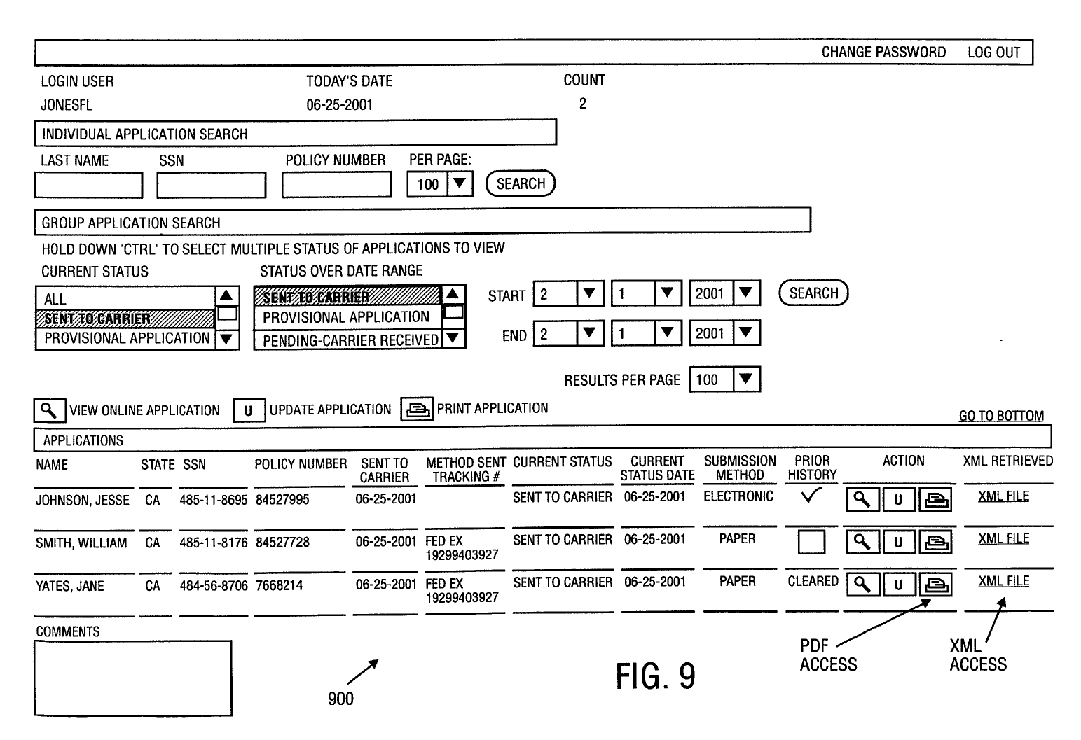

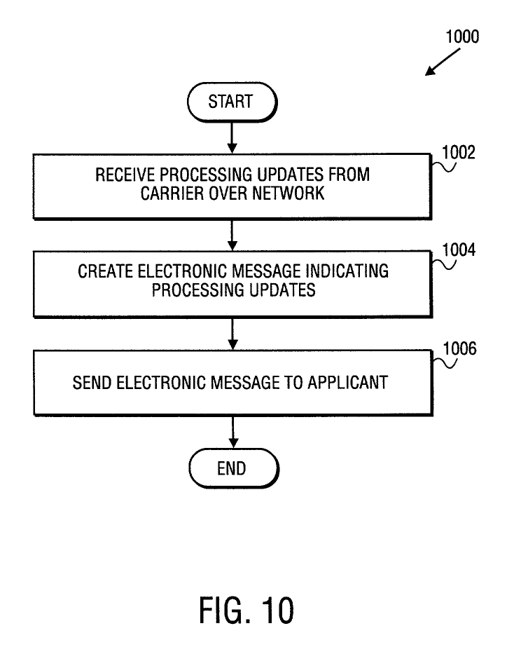

FIG. 8 is a flow diagram of one embodiment of a method 800 for collecting and processing data updates from a health insurance carrier over a network. The method begins, at processing block 802, with presenting a user interface for the health insurance carrier to use for processing the electronic application data. An exemplary user interface is described in more detail below in conjunction with FIG. 9. The method 800 continues, at processing block 804, with receiving processing updates from the carrier. Next, at processing block 806, method 800 continues with electronically communicating the processing updates made by the carrier to the applicant. One embodiment of communicating processing updates made by the carrier to the applicant is described in more detail below in conjunction with FIG. 10.

FIG. 9 illustrates an exemplary user interface 900 that may be provided to a health insurance carrier to use for processing the electronic application. Once the health insurance carrier receives the secure digital file, or other application, the carrier may want electronic assistance in processing the application. Furthermore, as a health insurance application is being processed, the health insurance carrier typically reviews the application data in stages and makes decisions about the application progressively. Hence, the carrier may want a processing tool that can be used progressively. In one embodiment, such a processing tool may be the user interface 900 provided to assist the health insurance carrier in processing the electronic application. In one embodiment, a broker may be presenting the user interface to the carrier over a network. In another embodiment, a department internal to the carrier, such as a sales department, may be presenting the user interface to another department also internal to the carrier, such as an underwriting department.

Referring to FIG. 9, the user interface 900 may present application data for immediate viewing. Viewable application data might include the name, state, and social security number of the applicant. Other information might include the date the application was sent to the health insurance carrier, and the method sent. The user interface may also allow the health insurance carrier to update the status of the health insurance application, to view and print the secure digital file, and to download data files associated with the application. In addition, the carrier may be allowed to download the application data in other electronic formats, such as an XML or HTML version of the application. Yet another feature of the user interface may allow the carrier to view the applicant's prior application history. In one embodiment, the carrier may be working with a broker. Thus, the user interface may further allow the health insurance carrier to make status updates or attach notes to the electronic application for the broker to communicate to the applicant.

FIG. 10 is a flow diagram of one embodiment of a method 1000 for electronically communicating processing updates to an applicant. The method 1000 begins, at processing step 1002, with receiving processing updates from the carrier. In one embodiment, a broker may be receiving updates from the carrier over a network. In another embodiment, a department internal to the carrier, such as a communications department, may be receiving the processing updates from another department internal to the carrier, such as an underwriting department. Next, at processing step 1004, the method 1000 continues with creating an electronic message indicating the processing update. The electronic message could be an email, an online chat, an “Instant Message”, an “ICQ” message, a video message, an audio message, etc. Then, at processing step 1006, the method 1000 continues with sending the electronic message to the applicant.

In conclusion, by utilizing the methods and apparatus of the present invention, health insurance applications can be processed electronically over a network, quickly and efficiently. The present invention revolutionizes the process of applying for health insurance. Until now, the processing time of a health insurance application averaged weeks. Now, with the aid of the present invention, the processing time of a health insurance application can be as little as days, hours, or minutes.

### Computer Architecture

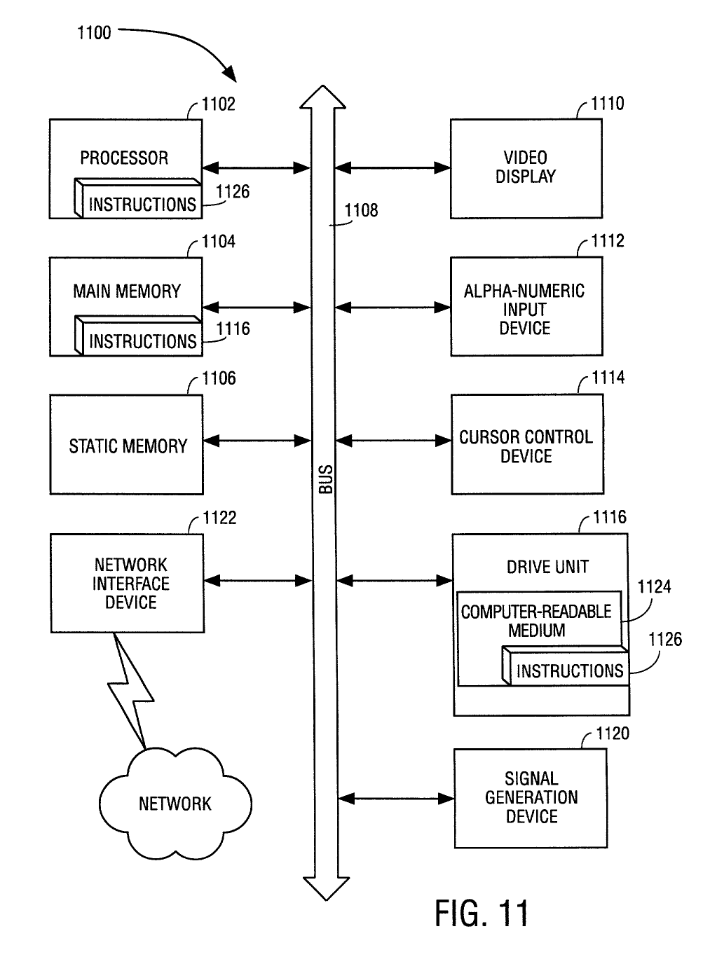

FIG. 11 shows a diagrammatic representation of machine in the exemplary form of a computer system 1100 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1100 includes a processor 1102, a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1120 (e.g., a speaker) and a network interface device 1122.

The disk drive unit 1116 includes a computer-readable medium 1124 on which is stored a set of instructions (i.e., software) 1126 embodying any one, or all, of the methodologies described above. The software 1126 is also shown to reside, completely or at least partially, within the main memory 1104 and/or within the processor 1102. The software 1126 may further be transmitted or received via the network interface device 1122. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to included, but not be limited to, solid-state memories, optical and magnetic disks, and carrier wave signals.

Thus, a method and apparatus for processing health insurance applications over a network have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

We claim:

1. A method for processing health insurance applications over a network, the method comprising:
presenting a user interface to an applicant over the network, the user interface including information pertaining to a medical plan selected by the applicant and facilitating input of application data by the applicant;
receiving the application data from the applicant via the network;
transforming the application data into a secure digital file; and
transmitting the secure digital file to the health insurance carrier.

2. The method of claim 1 further comprising providing the applicant a form of electronic payment.

3. The method of claim 2 further comprising assembling the form of electronic payment into the secure digital file.

4. The method of claim 1 further comprising providing the applicant a form of electronic signature to authenticate the applicant's intention to enter into a health insurance contract.

5. The method of claim 4 further comprising assembling the form of electronic signature into the secure digital file.

6. The method of claim 4 wherein providing the applicant a form of electronic signature further comprises:
requesting the applicant to type the applicant's name twice;
requesting the applicant to type the date;
providing the applicant with hyperlinks to portions of the application that have legally binding language; and
requesting the applicant to check a box or click a button indicating the applicant's intention to be legally bound.

7. The method of claim 1 wherein the electronic health insurance application is in the form of any one of an hypertext markup language (HTML) page, an extensible markup language (XML) page, a dynamic HTML page, and a JavaScript.

8. The method of claim 1 wherein the medical plan selected by the applicant varies for individual applicants, private group applicants, and commercial group applicants.

9. The method of claim 1 wherein presenting a user interface to an applicant over the network further comprises:
providing a user interface to enable the applicant to enter data required in an application;
verifying that the data entered by the applicant is appropriate for the application;
populating an electronic application with the application data provided by the applicant;
permitting the applicant to view the populated application; and
permitting the applicant to correct, reject, or approve the populated application.

10. The method of claim 9 further comprising allowing the applicant to create a customer account wherein the applicant can save application data.

11. The method of claim 9 wherein verifying that the data entered by the applicant is appropriate for the application further comprises analyzing the application data received from the applicant to determine, according to predetermined business rules, whether the applicant has provided appropriate information.

12. The method of claim 9 wherein providing a user interface to enable the applicant to enter data required in an application further comprises assisting the applicant to choose a health plan based on a plurality of factors pertaining to personal data of the applicant.

13. The method of claim 12 wherein the personal data comprises any one of the number of persons covered under the health plan, relation between the persons and the applicant, the age of the applicant, prior health history of the applicant, a desired price of the plan, a preference of the applicant regarding a health insurance carrier providing the plan, and a preference of the applicant regarding the type of benefits associated with each plan.

14. The method of claim 1 wherein transforming the application data into a secure digital file comprises assembling and encrypting the application data into a preformatted electronic document.

15. The method of claim 14 wherein the preformatted electronic document comprises unalterable content.

16. The method of claim 15 wherein the unalterable content is characterized by a fixed language, fixed font formats, and fixed style elements.

17. The method of claim 14 wherein the preformatted digital document is an Adobe™ portable document format (PDF) file.

18. The method of claim 14 further comprising:
associating a unique electronic key with the secure digital file; and
storing the unique electronic key in a look-up table.

19. The method of claim 14 further comprising:
allowing the applicant to view the secure digital file; and
allowing the applicant to reject, or approve the secure digital file.

20. The method of claim 1 further comprising:
presenting a user interface to the health insurance carrier for processing electronic application data; and
receiving processing updates from the health insurance carrier.

21. The method of claim 1 further comprising electronically communicating to the applicant processing updates made by the health insurance carrier.

22. The method of claim 20, wherein presenting a user interface to the health insurance carrier for processing electronic application data comprises allowing the health insurance carrier to view and print the secure digital file.

23. The method of claim 20, wherein presenting a user interface to the health insurance carrier for processing electronic application data comprises:
allowing the health insurance carrier to attach notes to the electronic application;
allowing the health insurance carrier to update the status of the application;
allowing the health insurance carrier to download attached data files associated with the health insurance application; and
allowing the health insurance carrier to upload a data file including processing updates.

24. The method of claim 20 wherein presenting a user interface to the health insurance carrier for processing electronic application data comprises allowing the health insurance carrier to search the prior history of the applicant.

25. The method of claim 21 wherein electronically communicating to the applicant the processing updates made by the carrier comprises creating an electronic message indicating the processing updates.

26. The method of claim 25 further comprising sending the electronic message to the applicant.

27. A system comprising:
a plurality of client devices;
a transaction facility coupled to plurality of client devices to receive client data from the client devices and transform the client data into a secure digital file; and
a plurality of health insurance carrier devices coupled to the transaction facility to receive the secure digital file and other client data.

28. An apparatus comprising:
an electronic presenter to present a user interface to an applicant over the network, the user interface including information pertaining to a medical plan selected by the applicant and facilitating input of application data by the applicant;
an application data processor to transform the application data into a secure digital file; and
an electronic transmitter to transfer the secure digital file to the health insurance carrier over said network.

29. The apparatus of claim 28 further comprising an electronic payment module to provide the applicant a form of electronic payment.

30. The apparatus of claim 28 further comprising an electronic signature module to provide the applicant a form of electronic signature to authenticate the applicant's intention to enter into a health insurance contract.

31. The apparatus of claim 30 wherein the electronic signature module requests the applicant to type a name into the electronic signature twice, requests the applicant to electronically date the signature, and requests the applicant to check a box, or click a button, indicating the applicant's intention to be legally bound.

32. The apparatus of claim 28 wherein the electronic health insurance application is in the form of any one of a hypertext markup language (HTML) page, an extensible markup language (XML) page, a dynamic HTML page, and a JavaScript.

33. The apparatus of claim 28 wherein the medical plan selected by the applicant varies for individual applicants, private group applicants, and commercial group applicants.

34. The apparatus of claim 28 wherein the electronic presenter provides a user interface to enable the applicant to enter data required in an application that corresponds to a chosen health plan.

35. The apparatus of claim 28 wherein the electronic presenter is further to assist the applicant to choose the medical plan based on a plurality of factors pertaining to personal data of the applicant.

36. The apparatus of claim 35 wherein the personal data includes the number of persons covered under the health plan, relation between the persons and the applicant, the age of the applicant, prior health history of the applicant, a desired price of the plan, and a preference of the applicant regarding a health insurance carrier providing the plan.

37. The apparatus of claim 28 further comprising a business rule module to analyze the application data received from the applicant to determine, according to predetermined business rules, whether the applicant has properly filled out the electronic health insurance application.

38. The apparatus of claim 28 wherein the application data processor is to transform the application data into a secure digital file by assembling and encrypting the application data into a preformatted electronic document.

39. The apparatus of claim 38 wherein the preformatted electronic document comprises unalterable content.

40. The apparatus of claim 38 wherein the unalterable content is characterized by a fixed language, fixed font formats, and fixed style elements.

41. The apparatus of claim 38 wherein the preformatted digital document is an Adobe™ portable document format (PDF) file.

42. The apparatus of claim 28 wherein the application data processor is to associate a unique electronic key with the secure digital file and to store the unique electronic key in a look-up table.

43. The apparatus of claim 28 further comprising an applicant user interface to allow the applicant to view the secure digital file before it is transmitted to the carrier, and to allow the applicant to approve or reject the application.

44. The apparatus of claim 28 further comprising a carrier user interface to allow the health insurance carrier to view and print the secure digital file.

45. The apparatus of claim 28 further comprising a carrier user interface to allow the health insurance carrier to attach notes to the electronic application, to allow the health insurance carrier to update the status of the application, to allow the health insurance carrier to download attached data files associated with the health insurance application, and to allow the health insurance carrier to upload a data file including processing updates.

46. The apparatus of claim 28 further comprising a carrier user interface to allow the health insurance carrier to search the prior history of the applicant.

47. The apparatus of claim 28 further comprising a status notifier to notify the applicant of the status of the application.

48. A computer readable medium that provides instructions, which when executed on a processor, cause said processor to perform operations comprising:
presenting a user interface to an applicant over the network, the user interface including information pertaining to a medical plan selected by the applicant and facilitating input of application data by the applicant;
receiving the application data from the applicant via the network;
transforming the application data into a secure digital file; and
transmitting the secure digital file and other application data to the health insurance carrier.
